(19) United States
(12) Patent Application Publication
(10) Pub. No.: US 2005/0200718 A1
(43) Pub. Date: Sep. 15, 2005

(54) Image photographing apparatus and method

(75) Inventor: Chang-Hee Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/047,769

(22) Filed: Feb. 2, 2005

(30) Foreign Application Priority Data
Mar. 10, 2004 (KR) 2004-16024

(51) Int. Cl. H04N 5/225

(52) U.S. Cl. 348/220.1; 348/340

(57) ABSTRACT

An image photographing apparatus is capable of photographing a still image and a motion picture through separate, dedicated lenses. The image photographing apparatus has a first lens of a first camera part for photographing a motion picture, a second lens of a second camera part for photographing a still image, a mode selection switch for selecting one of a motion picture mode for photographing the motion picture through the first lens and a still-image mode for photographing the still image through the second lens, and a controller for selectively driving one of the first and the second camera parts according to the mode selected by the mode selection switch.

### CROSS-REFERENCE TO RELATED APPLICATION

This application claims the benefit under 35 U.S.C. §119(a) of Korean Patent Application No. 2004-16024, filed Mar. 10, 2004, in the Korean Intellectual Property Office, the entire disclosure of which is hereby incorporated reference.

### BACKGROUND OF THE INVENTION

1. Field of the Invention

The present invention relates to an image photographing apparatus capable of photographing a motion picture and a still image using respectively dedicated lenses. More particularly, the present invention relates to an image photographing apparatus having a motion picture lens and a still image lens coplanarly disposed on a certain surface and comprising a mode selection switch for selecting one of a motion picture mode and a still image mode.

2. Description of the Related Art

In general, image photographing apparatuses are divided into a camera for photographing a still image and a camcorder for photographing a motion picture. Due to the distinctive functions and particularities of the camera and the camcorder, they have usually been produced and sold separately. Therefore, a user has to separately purchase the camera and the camcorder for both functions of still-image photographing and motion-picture photographing, respectively; however, this is uneconomical and also inconvenient for the user who must carry both.

To overcome the above problem, the present applicant has filed an application of an image photographing apparatus combining a camera and a camcorder, as shown in FIG. 1.

Referring to FIG. 1, a conventional image photographing apparatus comprises a main body 10, a camera unit 20, a display device 30 and a controller.

The main body 10 comprises a moving deck in which a tape cassette for recording a motion picture is detachably mounted, and a flash memory mounting portion in which a flash memory for recording a still image is detachably mounted.

The camera unit 20 is disposed at one side of the main body 10 and comprises a camcorder part for photographing a motion picture and a camera part for photographing a still image. The camera part and the camcorder part are aligned in a housing 21 so that a camcorder part lens 23 and a camera part lens (not shown) are on opposite sides of each other. The housing 21 is rotatably mounted at one side of the main body 10 by a hinge part. Between the main body 10 and the housing 21, a mode sensor which senses the turning of the housing 21 is provided to check which lens is selected. Because of the mode sensor, a user can selectively use the camera or the camcorder by turning the housing 21 with respect to the main body 10 by 180°. For example, if the camera part lens (not shown) is directed to the front, the mode sensor considers the camera part to be selected, and if the camcorder part lens 23 is directed to the front as shown in FIG. 1, the mode sensor considers the camcorder part to be selected.

The display device 30 is disposed at a rear portion of the main body 10 and comprises a viewfinder 31 showing a subject being photographed by the camcorder part or the camera part, and a liquid crystal display (LCD) 33.

The controller (not shown) is provided in the main body 10. The controller determines which of the camera part and the camcorder part is selected, according to a signal sensed by the mode sensor, and controls the camera part and the camcorder part to accordingly photograph a still image or a motion picture, respectively. Therefore, the motion picture photographed by the camcorder part is recorded on the tape cassette of the moving deck, and the still image photographed by the camera part is recorded on the flash memory mounted in the flash memory mounting portion.

For photographing the motion picture, the housing 21 of the camera unit 20 is turned so that the camcorder part lens 23 directs to the front. The controller perceives the camcorder part to be selected, through the mode sensor, and controls the camcorder part to record the motion picture on the tape cassette. When a user wants to take still-image photographs, the camera unit 20 is turned back by 180° so that the camera part lens is directed to the front. Therefore, the controller perceives the selection of the camera part through the mode sensor, and controls the camera part to record the still image on the flash memory. Accordingly, the user may carry only one apparatus for both motion-picture photographing and still-image photographing.

However, the conventional image photographing apparatus, which integrally comprises the functions of the camcorder and the camera, has a problem because it can be inconvenient to manually operate since the user has to turn the camera unit 20 by 180° when switching the function from one to the other.

### SUMMARY OF THE INVENTION

An aspect of the present invention is to solve at least the above problems and/or disadvantages and to provide at least the advantages described below. Accordingly, an aspect of the present invention is to provide an improved image photographing apparatus in which a camera lens and a camcorder lens face the same direction, and a switch is provided to select either the function of the camera or the camcorder, thereby facilitating the manual operation and minimizing the whole size of the apparatus.

In order to achieve the above-described aspects of the present invention, there is provided an image photographing apparatus having a first camera part for motion-picture photographing and a second camera part for still-image photographing, comprising a first lens of the first camera part, a second lens of the second camera part, which is mounted on the same surface as the first lens of the first camera part, a mode selection switch for selecting one of a motion picture mode for photographing a motion picture through the first lens and a still-image mode for photographing a still image through the second lens, and a controller for selectively driving the first camera part or the second camera part according to the photographing mode selected by the mode selection part. The second lens is disposed below the first lens. A flash is mounted at a higher position of the first lens.

Another aspect of the present invention is to provide a main body detachably mounting a tape cassette, a first lens mounted on a front of the main body, a first camera part mounted in the main body to photograph and record a motion picture captured by the first lens, a second lens mounted on the front of the main body at a predetermined distance from the first lens to face the same direction as the first lens, a second camera part mounted in the main body to photograph and record a still image captured by the second lens, a display device mounted in the main body to display the image captured through the lens of one of the first camera part and the second camera part as selected, a mode selection switch mounted at one side of the main body to select one of a motion picture mode for photographing a motion picture by the first camera part and a still-image mode for photographing a still image by the second camera part, and a controller for selectively driving the first camera part or the second camera part according to the photographing mode selected by the mode selection part. The second lens is disposed below the first lens

The display device comprises a viewfinder mounted in the main body to show the image captured by one of the first and the second camera parts, and a display panel rotatably mounted on at least one axis in the main body in order to show the captured image independently of the viewfinder.

The main body comprises a flash memory mounting portion for detachable mounting of a flash memory for recording the still image. The main body comprises a microphone unit for receiving an external sound signal.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a perspective view of a conventional image photographing apparatus capable of photographing a still image and a motion picture using dedicated lenses;

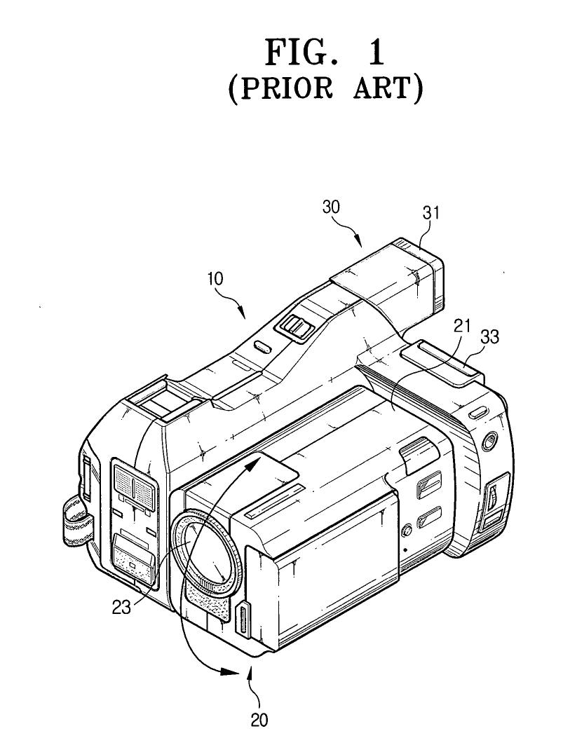

FIG. 2 is a perspective view of an image photographing apparatus according to an embodiment of the present invention;

FIG. 3 is a front view showing a lens part of the image photographing apparatus of FIG. 2; and

FIG. 4 is a schematic block diagram of the image photographing apparatus according to an embodiment of the present invention.

### DETAILED DESCRIPTION OF THE EXEMPLARY EMBODIMENTS

Hereinafter, an embodiment of the present invention will be described in detail with reference to the accompanying drawing figures.

In the following description, it is understood that the same drawing reference numerals refer to the same elements, features and structures throughout the drawings. The matters defined in the description such as a detailed construction and elements are provided to assist in a comprehensive understanding of the invention. Descriptions of well-known functions or constructions have been omitted for the sake of conciseness

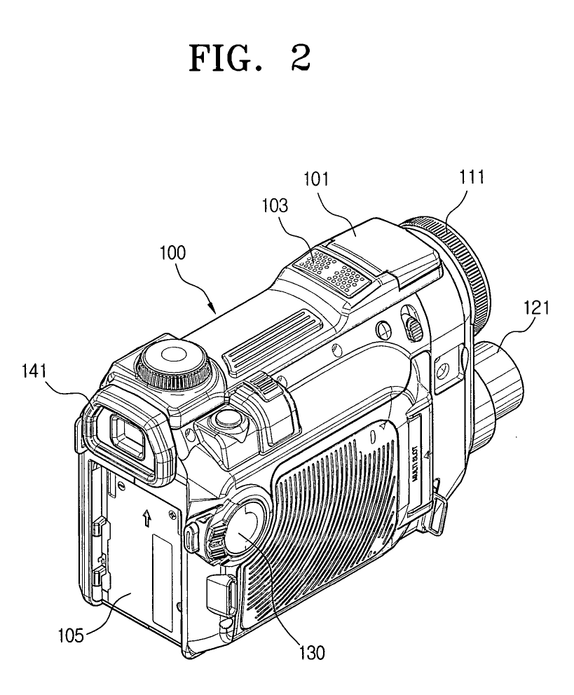

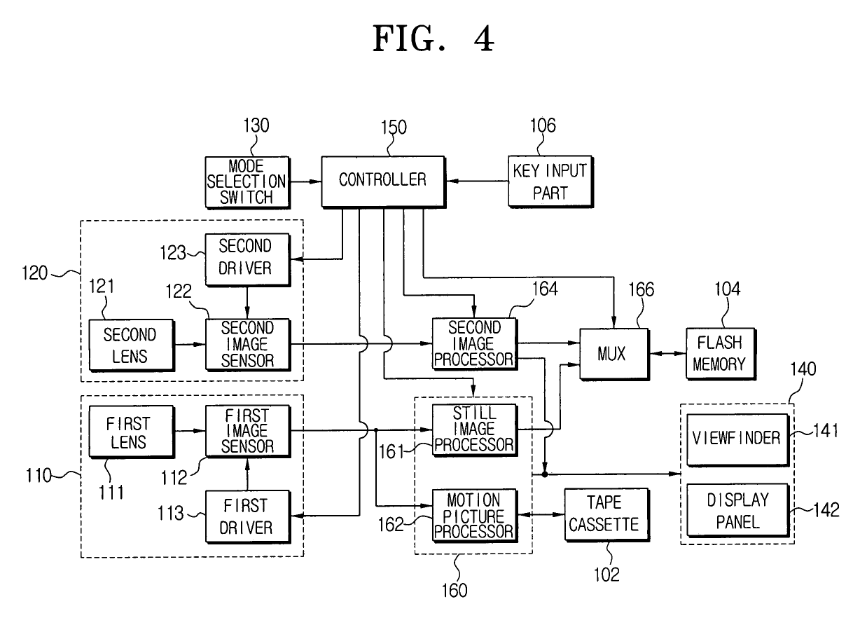

Referring to FIGS. 2 to 4, an image photographing apparatus according to an embodiment of the present invention comprises a main body 100, a first camera part 110, a second camera part 120, a mode selection switch 130, a display device 140 and a controller 150.

The main body 100 comprises a recorder for recording a motion picture or a still image on a recording medium that is detachable from the main body 100. For the recording medium, a hard disc, a memory stick, a digital video disc (DVD), a tape cassette or any other medium capable of recording digital data can be adopted. In this embodiment, a tape cassette 102 for recording a motion picture is employed by way of example, and a moving deck (not shown) is provided to mount the tape cassette 102 to the main body 100. A deck door (not shown) is openably attached at one side of the main body 100 to mount the tape cassette 102. A bottom of the main body 100 is open by the deck door such that the moving deck receives the tape cassette 102. The deck door and the moving deck will not be described in detail for the sake of conciseness since they are well known by those skilled in the art. In addition, the present embodiment preferably employs a flash memory for the recording medium, and the main body 100 comprises a flash memory mounting portion.

In FIG. 2, a flash 101 is provided on a top of the main body 100, and at a rear portion of the flash 101, a microphone unit 103 is provided to obtain external sounds. At a rear portion of the main body 100, a battery mounting portion 105 is provided for detachable mounting of a battery, which supplies power for the operation of the image photographing apparatus.

The first camera part 110 may be a camcorder for photographing images such as a motion picture. In this embodiment, a digital video camera is used. The first camera part 110 comprises a first lens 111 for capturing an external image, a first image sensor 112 for converting the motion picture or the still image photographed by the first lens 111 to an electric signal, and a first driver 113 controlled by the controller 150 to drive the first image sensor 112. The first lens 111 is mounted on the front of the main body 100, and the flash 101 is at a higher position than the first lens 111. A charged coupled device (CCD) is generally used for the first image sensor 112. The first image sensor 112 has fewer pixels than a second image sensor 122 to correspond to the lens of the digital video camera. When the mode selection switch 130 is in a mode for motion-picture photographing or a mode for still-image photographing by the first camera part 110, the controller 150 controls the first driver 113 to drive the first image sensor 112. The camera part 110 can take both motion picture photographs and still-image photographs. Since the first camera part 110 is used in general digital video cameras, such as a digital camcorder, a detailed description thereof will be omitted.

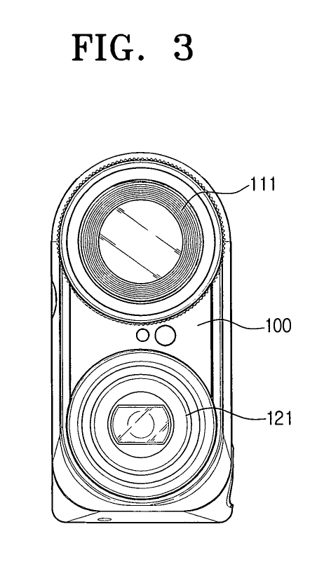

The second camera part 120 may be a digital still camera (DSC) for photographing a still image. The second camera part 120 comprises a second lens 121, which is for digital still cameras, a second image sensor 122 for converting the still image photographed by the second lens 121 into an electric signal, and a second driver 123 for driving the second image sensor 122. The second lens 121 and the first lens 111 are on the same surface parallel with each other. Therefore, the first and the second lenses face the same direction, and the optical axes of the first and the second lenses are parallel at a predetermined space from each other. Although the second lens 121 may be located at any positions with respect to the first lens 111, most preferably, the second lens 121 is disposed right below the first lens 111, as shown in FIG. 3. In this case, since the flash 101 is disposed higher than the first lens 111, which is for the camcorder, direct incidence of a light of the flash 101 to the second lens 121 can be prevented while photographing the still image through the second lens 121. Therefore, only by operating the mode selection switch 130, one of the first 111 and the second lenses 121 can be selected for photographing the motion picture or the still image, respectively. The CCD is generally used for the second image sensor 122, and the second image sensor 122 has more pixels than the first image sensor 112 to correspond to the lens of the digital still camera. The second driver 123 of the second camera part 120 is controlled by the controller 150. More specifically, when the still image mode is selected by the mode selection switch 130, the controller 150 controls the second driver 123 to drive the second image sensor 122. The second image sensor 122 converts a light received through the second lens 121 to the electric signal, thereby photographing the still image. Since the operation and structure of the second camera part 120 is the same as that of general digital still cameras, a detailed description thereof will be omitted.

The mode selection switch 130, provided at one side of the main body 100, has at least two contacts for selecting one of the motion picture mode and the still-image mode. In this embodiment, a rotary switch is adopted, although other suitable switching means may be used. The mode selection switch 130 may further comprise other functions besides the photographing function. For example, the mode selection switch 130 may comprise a function of playing photographed motion picture or displaying a still image through the display device 140 according to user's selection.

The display device 140 displays images photographed by the first and the second camera parts 110 and 120. For this, the display device 140 comprises a viewfinder 141 disposed at a rear portion of the main body 100 and a display panel 142 disposed at one side of the main body 100. As the display panel 142, a liquid crystal display (LCD) is generally used. Since the operation and structure of the viewfinder 141 and the display panel 142 are well known, a detailed description thereof will be omitted.

The controller 150 determines the photographing mode according to the signal transmitted from the mode selection switch 130, and accordingly drives the first camera part 110 or the second camera part 120. If the mode selection switch 130 is in the motion picture mode, the controller 150 drives the first camera part 110, and if the mode selection switch 130 is in the still-image mode, the controller 150 drives the second camera part 120. In the controller 150, predetermined control data is input and set by a key input part 106. In addition, the controller 150 selectively drives and controls a first image processor 160, which processes the signal from the first camera part 110, or a second image processor 164, which processes the signal from the second camera part 120, according to the photographing mode selected by the mode selection part 130. The first image processor 160 comprises a motion picture processor 162 for processing the motion picture photographed by the first camera part 110 and a still-image processor 161 for processing the still image photographed by the second camera part 120. The motion picture processor 162 processes an input motion picture signal to record the motion picture signal on a motion picture recording medium such as the tape cassette 102, and compresses the motion picture signal into a signal, which is displayable through the display device 140. The still-image processor 161 records an input still image signal on the still image recording medium such as the flash memory 104 and compresses the still image signal into a signal displayable through the display device 140. The second image processor 164 compresses the still image photographed by the second camera part 120 in order to record the compressed still image on the still-image recording medium, such as the flash memory 104, and processes the still image into a signal displayable through the display device 140.

The signals processed by the still-image processor 161 of the first image processor 160 and the second image processor 164 are selected by a multiplexer (MUX) 166 for recording on the still-image recording medium, which preferably is flash memory 104. The MUX 166 is controlled by the controller 150 to select the signal transmitted from one of the first and the second camera parts 110 and 120 which is corresponding to the set photographing mode. Furthermore, the MUX 166 operates in association with the mode selection switch 130 so as to be turned on or off corresponding to the power state of the second camera part 120.

Hereinbelow, the operation of the image photographing apparatus according to an embodiment of the present invention will now be described with reference FIGS. 2 through 4.

A power switch (not shown) is provided on the main body 100 (FIG. 2) is turned on first, and the mode selection switch 130 is set to either the motion picture mode and the still-image mode. The controller 150 determines the photographing mode of the mode selection part 130 and accordingly controls the first 110 or the second camera part 120 to photograph a subject. For instance, when the mode selection switch 130 is set to the motion picture mode, the controller 150 drives the first camera part 110.

In the motion picture mode, when a command for photographing is input through the key input part 106, the controller 150 controls the first driver 113 to drive the first image sensor 112. The motion picture photographed through the first lens 111 is converted to an electric signal at the first image sensor 112. The electric signal is compressed into a signal recordable on the tape recorder 102 by the motion picture processor 162 of the first image processor 160. The compressed motion picture signal is recorded on the tape recorder 102 and displayed in real-time through the viewfinder 141 and the display panel 142. The motion picture signal recorded on the tape recorder 102 can be transmitted to external apparatuses, such as a personal computer (PC) through a universal serial bus (USB) port, or the like. A still image can also be photographed by the first camera part 110, while in the motion picture mode. The still image photographed by the first camera part 110 is transmitted to the still image processor 161 of the first image processor 161 and compressed into a signal recordable on the flash memory 104.

If the user wants to change from the motion picture mode to the still-image mode, the user operates the mode selection switch 130 to select the still-image mode. The controller 150 drives the second camera part 120 according to the signal from the mode selection switch 130 to operate in the still-image mode. Here, when the command for photographing is input through the key input part 106 of the main body 100, the controller 150 controls the second driver 123 to drive the second image sensor 122. The still image photographed through the second lens 121 is converted into an electric signal at the second image sensor 122. The electric signal is compressed by the second image processor 164 into a signal recordable on the flash memory 104. The compressed still image signal is recorded on the flash memory 104 through the MUX 166, and displayed in real-time through the viewfinder 141 or the display panel 142. By selectively operating the key input part 106, the user can also transmit the image signal recorded on the flash memory 104 to the PC using the USB port, or record it on other suitable auxiliary memory.

As can be appreciated from the above description, the image photographing apparatus according to an embodiment of the present invention has the lenses 111 and 121 of the two camera parts 110 and 120, respectively, for photographing a motion picture and a still image in a manner that the both lenses 111 and 121 face the same direction, being mounted on a front of the main body 100. In addition, the image photographing apparatus comprises a mode selection switch 130 for selecting one of the first and the second lenses 111 and 121 for photographing. Therefore, the user is able to select a desired photographing mode by operating the mode selection switch 130, and accordingly, the first or the second camera part 110 or 120 corresponding to the selected mode is driven to photograph the motion picture or the still image. This embodiment not only enables integral construction of the digital still camera and the camcorder but also facilitates the user's operation of selecting the photographing modes by use of the mode selection switch 130.

According to the above image photographing apparatus, the lenses which are respectively for a camera and a camcorder are mounted on a common surface to face in the same direction, and the desired lens to be used can be selected by the mode selection switch 130. Therefore, the selection operation is simplified.

While the invention has been shown and described with reference to certain embodiments thereof, it will be understood by those skilled in the art that various changes in form and details may be made therein without departing from the spirit and scope of the invention as defined by the appended claims.

1. An image photographing apparatus having a first camera part for motion-picture photographing and a second camera part for still-image photographing, the image photographing apparatus comprising:
a first lens of the first camera part;
a second lens of the second camera part, which is mounted in the same plane as the first lens of the first camera part;
a mode selection switch for selecting one of a motion picture mode for photographing a motion picture through the first lens and a still-image mode for photographing a still image through the second lens; and
a controller for selectively driving the first camera part or the second camera part according to the photographing mode selected by the mode selection part.

2. The image photographing apparatus of claim 1, wherein the second lens is disposed below the first lens.

3. The image photographing apparatus of claim 2, wherein a flash is mounted at a higher position than the first lens.

4. An image photographing apparatus comprising:
a main body detachably mounting a tape cassette therein;
a first lens mounted on a front of the main body;
a first camera part mounted in the main body to photograph and record a motion picture captured by the first lens;
a second lens mounted on the front of the main body at a predetermined distance from the first lens, and facing the same direction as the first lens;
a second camera part mounted in the main body to photograph and record a still image captured by the second lens;
a display device mounted in the main body to display the image captured through the lens of either the first camera part and the second camera part as selected;
a mode selection part mounted at one side of the main body to select one of a motion picture mode for photographing a motion picture by the first camera part and a still-image mode for photographing a still image by the second camera part; and
a controller for selectively driving the first camera part or the second camera part according to the photographing mode selected by the mode selection part.

5. The image photographing apparatus of claim 4, wherein the second lens is disposed below the first lens.

6. The image photographing apparatus of claim 5, wherein the display device comprises:
a viewfinder mounted in the main body to show the image captured by one of the first and the second camera parts; and
a display panel rotatably mounted on at least one axis in the main body in order to show the captured image independently of the viewfinder.

7. The image photographing apparatus of claim 5, wherein the main body comprises a flash memory mounting portion for detachable mounting of a flash memory for recording the still image.

8. The image photographing apparatus of claim 5, wherein the main body comprises a microphone unit for receiving external sound signals.

9. A method of photographing images using an image photographing apparatus having a first camera part for motion-picture photographing and a second camera part for still-image photographing, the method comprising the steps of:
mounting a first lens of the first camera part and a second lens of the second camera part in the same plane with a housing;
selecting one of a motion picture mode for photographing a motion picture through the first lens and a still-image mode for photographing a still image through the second lens using a mode selection switch; and
selectively driving the first camera part or the second camera part according to the photographing mode selected by the mode selection part using a controller.

10. The method of claim 9, wherein the second lens is disposed below the first lens.

11. The method of claim 10, wherein a flash is mounted at a higher position than the first lens.
